(19) United States
(12) Patent Application Publication
(10) Pub. No.: US 2005/0195016 A1
(43) Pub. Date: Sep. 8, 2005

(54) Small size circuit for detecting a status of an electrical fuse with low read current

(76) Inventor: Jui-Jen Wu, Yonghe City (TW)

Correspondence Address: DUANE MORRIS, LLP;IP DEPARTMENT, ONE LIBERTY PLACE, PHILADELPHIA, PA, 19103-7396, US

(21) Appl. No.: 10/941,587

(22) Filed: Sep. 14, 2004

Related U.S. Application Data
(60) Provisional application No. 60/551,159, filed on Mar. 8, 2004.

(51) Int. Cl. H01H 37/76

(52) U.S. Cl. 327/525

(57) ABSTRACT

An electrical resistive fuse element detection circuit includes a resistive fuse element of a first resistance; a resistive reference element of a second resistance different than the first resistance; first and second inverters; and first and second active devices for coupling the fuse and reference elements to the first and second inverters. The resistive fuse element is intact if a differential voltage is generated by the first and the second inverters when a low clock signal input signal is applied to the first and the second active devices. The resistive fuse element is not intact if a single voltage is generated by one of the first and the second inverters when the low clock signal input signal is applied to the first and the second active devices.

### RELATED APPLICATIONS

This application claims the benefit of Provisional Application No. 60/551,159 filed Mar. 8, 2004, the entire disclosure of which is incorporated herein by reference.

### FIELD OF THE INVENTION

The present invention relates to semiconductor devices, and more particularly to semiconductor fuses.

### BACKGROUND OF THE INVENTION

Fuses have been used in semiconductor circuits for a variety of purposes. For example, memory circuits typically use fuses to implement memory redundancy. Discussions and examples of fuse circuits which are programmable are disclosed in U.S. Pat. No. 6,498,526 entitled “Fuse circuit and program status detecting method thereof,” U.S. Pat. No. 4,446,534 entitled “Programmable Fuse Circuit,” and in U.S. Pat. No. 5,953,279 entitled “Fuse Option Circuit For Memory Device”.

Semiconductor fuses are typically made non-conductive either by application of a large voltage (relative to power supply voltage magnitude) or by use of laser light. In either event, a circuit is required to indicate the existing status of whether or not the fuse has successfully been made nonconductive. Resistive fuse elements are also typically electrically programmable fuses, where one resistive fuse element acting as a resistor is configured so as to have a larger resistor value than that of a second resistive fuse element when the second resistive fuse element is in an intact state, i.e. a conductive state.

In typical semiconductor circuits, a poly fuse and reference resistor are placed in series with an associated circuit, e.g. a latch sensing circuit. However, it is often the case that a poly fuse must be placed in parallel with another circuit device used to blow the poly fuse. This other circuit device may cause a circuit loading mismatch and a subsequent incorrect operation of the circuit.

Accordingly, what is needed in the art is a fuse circuit that avoids the above described circuit loading mismatch and circuit operational problems.

### BRIEF DESCRIPTION OF THE DRAWINGS

FIG. 1 is a schematic of an exemplary electrical resistive fuse element detection circuit.

FIG. 2 is a flowchart of an exemplary method of operation of the electrical resistive fuse element detection circuit of FIG. 1.

FIG. 3 is an exemplary timing diagram of the electrical resistive fuse element detection circuit of FIG. 1.

### DETAILED DESCRIPTION OF THE INVENTION

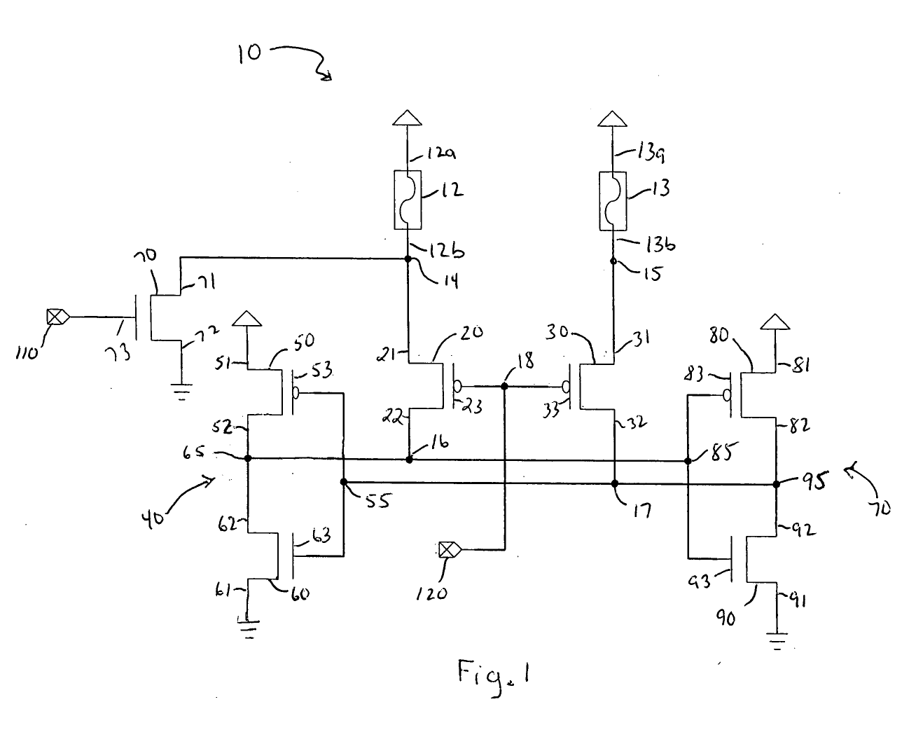

FIG. 1 illustrates an exemplary embodiment of an electrical resistive fuse element detection circuit 10 according to the present invention. The electrical resistive fuse element detection circuit 10 comprises resistive fuse element 12 having first and second terminals 12a and 12b; reference resistive fuse element 13 having first and second terminals 13a and 13b; P-channel metal-oxide semiconductor (PMOS) transistor 20 having source/drain 21, source/drain 22, and gate 23; PMOS transistor 30 having source/drain 31, source/drain 32, and gate 33; first inverter 40; second inverter 70; and optionally, N-channel metal-oxide semiconductor (NMOS) transistor 70 forming a programming circuit and having source/drain 71, source/drain 72, and gate 73.

Data signal input 110 is coupled to the gate 73 of programming transistor 70. Source/drain 72 of programming transistor 70, second terminal 12b of resistive fuse element 12, and source/drain 21 of transistor 20 are coupled at node 14. Source/drain 22 of transistor 20 is coupled to the first inverter 40 at node 16. Second terminal 13b of reference resistive fuse element 13 and source/drain 31 of transistor 30 are coupled at node 15. Source/drain 32 of transistor 30 is coupled to second inverter 70 at node 17. Gate 23 of transistor 20 and gate 33 of transistor 30 are coupled at node 18. Clock signal input 120 is coupled to gates 23 and 33 of transistors 20 and 30 at node 18.

Resistive fuse element 12 and reference resistive fuse element 13 are typically electrically isolated from the other components of the electrical fuse resistive element detection circuit 10. In some embodiments, resistive fuse element 12 comprises a poly fuse. Resistive fuse element 12 has a resistive value in an intact or conductive state, e.g., prior to the application of a programming voltage by programming circuit transistor 70, which is less than the resistive value of reference resistive fuse element 13.

First inverter 40 may comprise a PMOS transistor 50 having source/drain 51, source/drain 52, gate 53, and NMOS transistor 60 having source/drain 61, source/drain 62, and gate 63. Gate 53 of PMOS transistor 50 is coupled to gate 63 of NMOS transistor 60 at node 55, which forms an input of first inverter 40. Source/drain 52 of PMOS transistor 50 is coupled to source/drain 62 of NMOS transistor 60 at node 65, which forms an output of first inverter 40.

Second inverter 70 may comprise PMOS transistor 80 having source/drain 81, source/drain 82 and gate 83, and NMOS transistor 90 having source/drain 91, source/drain 92, and gate 93. Gate 83 of PMOS transistor 80 is coupled to the gate 93 of NMOS transistor 90 at node 85, which forms an input of second inverter 70. Source/drain 82 of PMOS transistor 80 is coupled to source/drain 92 of NMOS transistor 90 at node 95, which forms an output of second inverter 70.

The output 65 of first inverter 40 is coupled to source/drain 21 of transistor 20 and the input 85 of second inverter 70 at node 16. The output 95 of second inverter 90 is coupled to the source/drain 31 of transistor 30 and the input 55 of first inverter 40 at node 17.

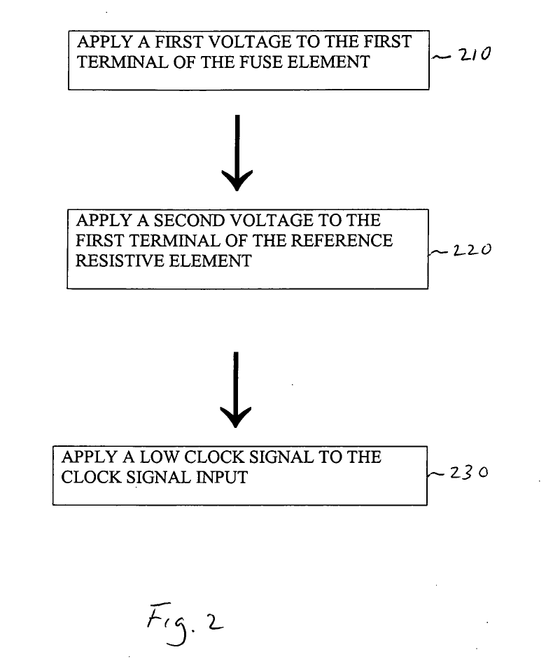

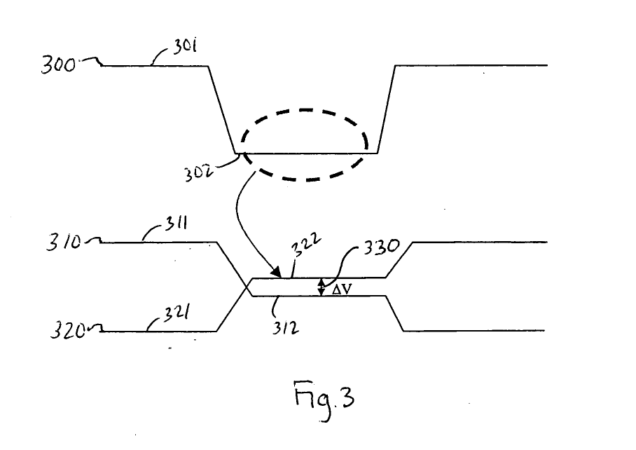

An exemplary method for operating the electrical resistive fuse element detection circuit 10 of the present invention to detect whether a resistive fuse element is intact (conductive) or not intact (non-conductive) will now be described with reference to FIGS. 1-3. In step 210 of FIG. 2, a first voltage is applied to first terminal 12a of resistive fuse element 12, in step 220 a second reference voltage substantially equal to the first voltage is applied to first terminal 13a of reference resistive fuse element 13, and in step 230 a clock signal is applied to clock signal input 120. As shown in the timing diagram of FIG. 3, when the clock signal 300 applied to clock signal input 120 is high (reference numeral 301) a voltage 310 of voltage level 311 is produced at the output 65 of first inverter 40 and a voltage 320 of voltage level 321 is produced at the output 95 of second inverter 70.

When the clock signal 300 applied to clock signal input 120 goes low the electrical resistive fuse detection circuit 10 responds as follows. NMOS transistor 60 of first inverter 40 limits the current of the voltage 310 at output 65 of first inverter 40 while at the same time, transistor 20 pulls the voltage 310 (lowered in magnitude by the current limiting NMOS transistor 60) at output 65 of first inverter 40 down to a voltage level 312. NMOS transistor 90 of second inverter 70 limits the current of the voltage 320 at output 95 of second inverter 70 while at the same time, transistor 30 pulls the voltage 320 (lowered in magnitude by the current limiting NMOS transistor 90) at output 95 of second inverter 70 up to a voltage level 322. The voltage differential 330 between the voltage levels 312 and 322 is latched or stored in a loop formed by the first and second inverters 40 and 70. The latched voltage differential 330 may be used to determine the present resistive value of resistive fuse element 12. The present resistive value of resistive fuse element 12 may be compared with the original resistive value of resistive fuse element 12 to determine if the element is intact or not.

While the foregoing invention has been described with reference to the above, various modifications and changes can be made without departing from the spirit of the invention. For example, other types of active devices, e.g. diodes, may be used in place of one or more of the transistors described above. These and other such modifications and changes are considered to be within the scope of the appended claims.

1. An electrical resistive fuse element detection circuit comprising:
first and second inverters; and
first and second active devices for coupling resistive fuse and reference elements to the first and second inverters;
wherein the resistive fuse element is intact when a low clock signal input signal is applied to the first and the second active devices and a differential voltage is generated by the first and the second inverters and wherein the resistive fuse element is not intact when the low clock signal input signal applied to the first and the second active devices causes a single voltage to be generated by one of the first and the second inverters.

2. The circuit according to claim 1, wherein the first active device comprises a first transistor and the second active device comprises a second transistor, each of the first and second transistors having a gate.

3. The circuit according to claim 2, wherein the low clock signal input is applied to the gates of the first and second transistors.

4. The circuit according to claim 2, wherein the first and second transistors are each P-type.

5. The circuit according to claim 2, wherein the first transistor including a source and a drain, one of the source and a drain of the first transistor for coupling the resistive fuse element and the second transistor including a source and a drain, one of the source and drain of the second transistor for coupling the resistive reference element.

6. The circuit according to claim 5, wherein the other one of the source and the drain of the first transistor is coupled to an input of the second inverter and an output of the first inverter and the other one of the source and the drain of the second transistor is coupled to an input of the first inverter and an output of the second inverter.

7. The circuit according to claim 1, wherein the first active device is coupled to an input of the second inverter and an output of the first inverter.

8. The circuit according to claim 7, wherein the second active device is coupled to an input of the first inverter and an output of the second inverter.

9. The circuit according to claim 8, wherein the differential voltage is generated at the outputs of the first and second inverters and the single voltage is generated at one of the outputs of the first and second inverters.

10. The circuit according to claim 1, wherein the second active device is coupled to an input of the first inverter and an output of the second inverter.

11. The circuit according to claim 1, wherein each of the first and second inverters comprises a pair of transistors.

12. The circuit according to claim 11, wherein each pair of transistors are in a CMOS configuration.

13. The circuit according to claim 11, wherein each pair of transistors includes a P-type transistor.

14. The circuit according to claim 11, wherein each pair of transistors includes a N-type transistor.

15. A method of detecting whether an electrical resistive fuse element is intact, the method comprising the steps of:
coupling resistive fuse and reference elements to first and second inverters using first and second active devices;
applying a low clock input to the first and second active devices;
observing whether a differential voltage is generated by the first and the second inverters or a single voltage is generated by one of the first and the second inverters, the differential voltage being indicative that the resistive fuse element is intact and the single voltage being indicative that the resistive fuse element is not intact.

16. An electrical resistive fuse element detection circuit comprising:
a resistive fuse element of a first resistance;
a resistive reference element of a second resistance different than the first resistance;
first and second inverters; and
first and second active devices for coupling the fuse and reference elements to the first and second inverters;
wherein the resistive fuse element is intact when a low clock signal input signal is applied to the first and the second active devices and a differential voltage is generated by the first and the second inverters and wherein the resistive fuse element is not intact when the low clock signal input signal applied to the first and the second active devices causes a single voltage to be generated by one of the first and the second inverters.
